(19) United States
(12) Patent Application Publication
(10) Pub. No.: US 2004/0143555 A1
(43) Pub. Date: Jul. 22, 2004

(54) Portable system for storing and issuing predetermined keys for authentication and authentication procedure

(76) Inventors: Jose Agustin Francisco Javier Vega Crespo, Madrid (ES); Eduardo Cantero Real, Madrid (ES)

Correspondence Address: John C. McMahon, PO Box 30069, Kansas City, MO, 64112, US

(21) Appl. No.: 10/752,639

(22) Filed: Jan. 7, 2004

(30) Foreign Application Priority Data
Jul. 9, 2001 (ES) P200101599

(51) Int. Cl. G06F 17/60; H04K 1/00; H04L 9/00

(52) U.S. Cl. 705/67

(57) ABSTRACT

Portable device allowing to carry out the authentication between two interlocutors, for which both the user of the portable system and the other interlocutors or computers have the same digits stored in the rows of a table, which have been randomly generated at a previous time. Each table contains a string of numbers ordered in four or more columns, so that once the user has accessed the system by means of an access code he/she can send the first number to the interlocutor (computer) together with the reference number of the device; the interlocutor will then locate the row in this table and send a second number to the user, who will send back the third number and, finally, the server sends the fourth number to the user. All of this is in the scope of an authentication process. The portable system is comprised of a processor, a display, a communications port, keyboard, a dc-dc converter and a solar panel power source.

### OBJECT OF THE INVENTION

The object of the present invention is a portable system for storing and issuing dynamic keys, created randomly, which have been exchanged between two or more participants in future dialogues for their use as an authentication and/or encryption element in the dialogues to be held between them.

The authentication consists of a mutual recognition between users, to ensure that each interlocutor is who it claims to be.

The portable system stores and issues the keys, which will consist of strings of four digits that have been predetermined randomly.

The present invention is characterised in that the authentication system is portable and can be carried anywhere.

A further characteristic of the present invention is that the digits that form the strings are not obtained as a function of any time variable, so that their validity is not limited to any time period. In order to carry out the authentication procedure it is only necessary that the participants in the dialogue share the digits, and it is possible to extend these dialogues to more participants.

Thus, the system is characterised by enabling authentication among the participants in a dialogue without requiring a synchronised connection of said participants.

It should be remarked that the system is scalable as regards the digits forming a string to be used in a dialogue for which the authentication support is provided, as well as the fact that a dialogue can take place using more than one string of digits.

The system is characterised by its autonomy, as it is provided with a solar panel in charge of its power supply.

### BACKGROUND OF THE INVENTION

Hitherto, most authentication systems for participants in a dialogue act in a single sense, that is, tile participant initiating the dialogue is the only one authenticated, and it is assumed that the other one is the participant that was called. This authentication system in fact has the disadvantage of being incomplete, and in order to solve this drawback complex and closed systems are designed with a rigidity that prevents their use from environments other than those for which the system was designed.

Some attempts have been made at solving this problem . ES 2 117 764 discloses a process for authentication by an offline terminal of a portable object, including a processing circuit able to deliver a secondary value (Rx) from a primary value (Qi) transmitted by the terminal. An authentication table is placed in the terminal which associates a series of primary values (Qi) and a series of control values (Ui), each control value being the transformation by one way function of the secondary value (Rx) calculated by the processing circuit of all authentic portable object. At the time of connection of a portable object with the offline terminal, one of the primary values (Qi) from the table is transmitted to the portable object, the one way function is applied by the terminal to the secondary value (Rx) received from the portable object, and the result obtained is compared to the corresponding control value (Ui) from the table. This solves partially, the complex circuit problem of the portable object but does not solve the need to have a costly one way function proccessor in the terminal, nor the lack of the bidirectional authentication.

Many other authentication systems are encompassed within a data transfer protocol between two units (two computers or two persons) where their mutual authentication is carried out by a synchronised key generation process. Said keys are exchanged continuously, so that after the synchronisation between the two units has been established and a key has been generated, said key is valid only for a certain predetermined period that corresponds to the periods in which changes the time variable used in the key generation algorithm.

These authentication systems have the disadvantage of requiring a synchronisation between the elements, so that once these are synchronised keys can be exchanged that are valid for a predefined period. These systems are complex and in certain cases time constraints limit their use.

Therefore, the object of the present invention is to provide a portable system for storing and issuing predetermined keys, so that it is not necessary to synchronise the key issuers of the interlocutors in order to obtain their full authentication.

### DESCRIPTION OF THE INVENTION

The present invention of a portable system for storing and issuing randomly predetermined keys for authentication consists of a system that can have the size of a portable calculator, on which a string of numbers has been recorded which will be used in the authentication procedure.

The system lacks any algorithm for generating numbers, and instead it has a stored table of randomly generated numbers; thus, it is not possible to know how the numbers that appear on the display have been calculated.

Te number table stored in the portable system is also provided to the participants in the dialogue. One of the interlocutors, that may be a computer, will have as many tables as the number of interlocutors in its dialogues, with a single one used for each interlocutor (system user) that will correspond with the one held in said interlocutor.

In order to access the keys stored in the machine an access code is entered in the portable device known only to its owner. This device access code shall have been set by the owner when initialising the unit. If this access code were forgotten a new one could be entered to replace the old one, by using a second code provided by the supplier of the device. If an incorrect access code is entered three consecutive times the device will be blocked, and its reinitialisation will require identification before the supplier, that will provide another code to enable this operation.

The internal table stored in the machine will comprise a fixed number of rows, with each row having four or more columns holding numbers. The first number will identify the row in the table and will comprise as many digits as is advisable in view of the security level required for the environment of the dialogues. This number will allow numbering the dialogues established between interlocutors. When the device user requests a set of keys for a dialogue the device will show on a first display the first digit of the row, which will remain on the display until the other digits are shown on a second display and the dialogue ends. The other digits of the row will be shown on the second display and each will be preceded by a letter, starting with the letter A, which will provide its storage order within a row and a reference for each of the digits stored in a row.

Each time all the digits of a row are displayed the device will mark this row as already used and it will not appear on the display again for use in another dialogue.

When the device user requests a set of keys for a dialogue the device will provide the first row it finds that has not been used before.

To describe the procedure that will allow authentication of the participants by means of this device, a description is provided below of the process between two interlocutors.

Once the two participants in a dialogue, say a person X and a computer Y, have the same table, and after the owner X of the device has entered its access code in the device and requests by a keystroke a set of keys for a dialogue, the device will show on a first display a number that will be used as the number of the dialogue to be established with the other interlocutor, Y. This dialogue number together with the reference number of the device will be sent to the other interlocutor, Y.

The interlocutor Y receiving these two numbers uses the reference number to find the table to be used and uses the dialogue number to find the row with the numbers used as the keys in this dialogue. It then extracts the first key number from this row and sends it to interlocutor X, who initiated the dialogue. The interlocutor X will check that this key agrees with the number shown on the second display, thereby identifying the interlocutor Y.

When X must send new data to Y it will instruct the device to display the following key in the row, attaching this number to the message that is sent, as well as the device and dialogue reference numbers.

Lastly, interlocutor Y can accept the dialogue or supply more data to X using a third key, attaching the same reference and dialogue numbers, which will be checked by X by viewing said third key in the display.

In addition to the above described method for using the device in which the device user requests a set of keys for a new dialogue, there is another mode of use in which the user asks the device to display the keys associated to the dialogue number that he/she enters in it and that will correspond to that received from its interlocutor in this dialogue.

The number of keys stored in a row will depend on the specific needs of the dialogues to be supported.

Depending on the security requirements of the environment in which the dialogue takes place, the keys, i.e. the digits associated to a dialogue number, can be used by a software component to encrypt the message that is sent (except for the device reference number and the dialogue number) and to unencrypt it when received to obtain its contents and the associated key after entering the key agreed for encryption, thatcan be the following number in the row of the key associated to the message.

This same procedure for using the device is valid for more interlocutors. In this case it is only necessary that the numbers stored in a row be shared by all and be requested to each other according to the characteristics of the dialogue.

In the case of more than two interlocutors, if the dialogue requires a greater security the keys stored in each row can be divided into groups. Each group of keys available for a participant will be shared by said participant and the other participant, so that each row of its key table will have as many groups of keys as there are interlocutors with the participant. Thus, only the emitter and receiver of a message share the keys and it is not possible to impersonate another participant in the dialogue. This allows that if any of the participants in the dialogue does not agree to end it the dialogue cannot be considered as correctly ended, as no other participant can impersonate the former.

### DESCRIPTION OF THE DRAWINGS

As a complement of the description provided below and in order to aid a better understanding of its characteristics, the present description is accompanied by a set of drawings with figures where, for purposes of illustration only and in a non-limiting manner, the most significant characteristics of the invention are shown.

FIG. 1 shows a schematic representation of the portable system, showing all of its component parts.

FIG. 2 shows the tables of the user and of the server or second interlocutor, their configuration and the mode of exchanging the numbers that they comprise.

### PREFERRED EMBODIMENT

In view of the aforementioned figures, a description of a preferred embodiment of the invention is provided together with an explanation of the drawings.

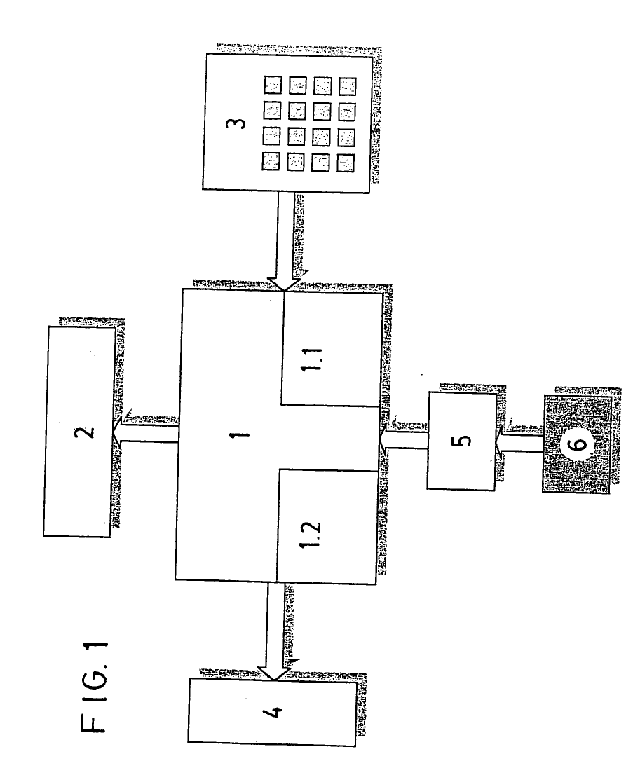

FIG. 1 shows the portable system composed of a low-consumption processor with a data memory (1.2) and a program memory (1.1). Said processor receives the information provided by the keyboard (3) or by any other means of data input used to supply the key allowing access to the system.

The processor communicates with a display (2), which, in a numerical code or in any other, will show the digits stored in the row to allow the authentication. It is also provided with a communications port (4) for communication with other devices participating in the dialogue to allow receiving or emitting keys shared by the interlocutors. Finally, it is provided with a dc-dc converter to supply the power required by the processor (1). The power is supplied to the converter (5) from a solar panel (6).

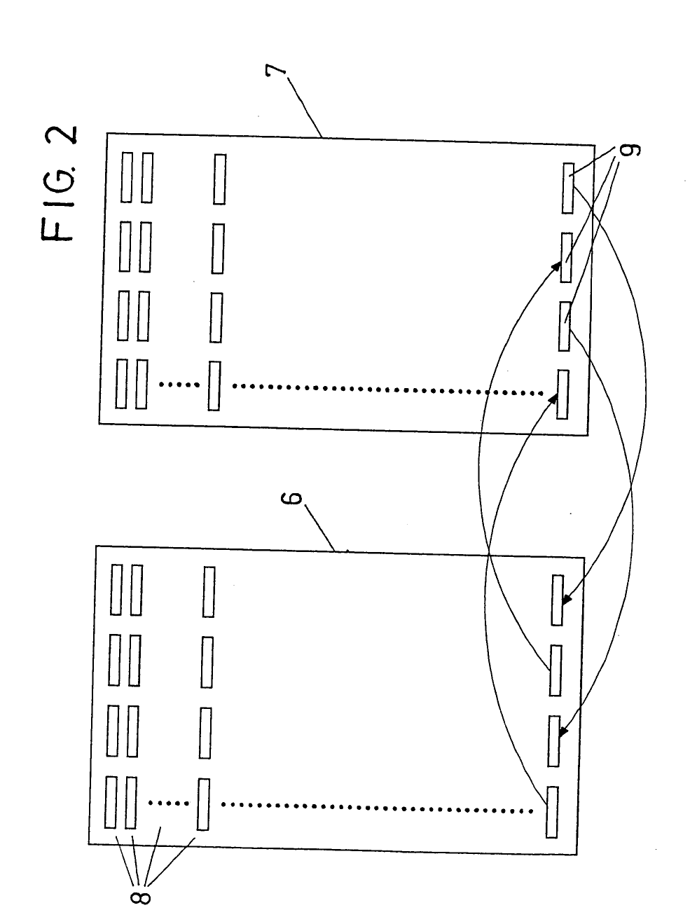

FIG. 2 shows the tables (6) and (7), which are respectively the table found in the portable system of the user, and the table in the computer or second interlocutor. No other user can have another identical table unless it is requested as another interlocutor in the dialogue.

The digits stored in the rows are randomly generated prior to being recorded in the devices. They are generated by randomisation modules so that there is no way to decipher the table digits.

The two tables (6) and (7) thus contain the same information. This information is arranged in rows (8) of four or more columns (9).

During the authentication process, after the user has entered the access code and requested set of keys for a new dialogue, four or more numbers are issued (the dialogue identifier and three or more keys) belonging to one row, and the user must send, together with the reference number of the device, the first and third numbers to the computer or second interlocutor. The reference number is used by the interlocutor to know which table it must use in the dialogue that is being initiated and the first number is used to know which row is being used, and to check, if this row exists, the authenticity of its interlocutor and the data received from said interlocutor. The third and successive numbers occupying an odd-numbered column are used to confirm the authenticity of the following messages sent to the interlocutor in the dialogue.

In addition, the computer or second interlocutor sends to the user the second and successive numbers occupying an even-numbered column of the row with the same purpose. The second number or key is used by the user to ensure that the server is in fact who it claims to be, after checking the agreement with the second number. Also, the numbers after the third one can be used to encrypt/unencrypt the messages as determined in the dialogue development procedure.

It is not considered necessary to extend this description to allow an expert in the field to understand the scope of the invention and the advantages derived thereof

The materials, shape, size and arrangement of the component elements may change as long as the essence of the invention is not affected.

The terms employed in this description must be understood in a wide and non-limiting sense.

1. Authentication procedure in a dialogue between an user and an interlocutor, characterized in that both the user and the interlocutor share the same numbers randomly generated and stored in two tables, so that after the user enters an access code the system accesses a row of four or more numbers and the first number is sent with the reference number of the device of the user to the interlocutor so that the interlocutor recognize the working row and table, the second number is then sent by the interlocutor to the user, which allows the user to check authenticity of the interlocutor after comparing it to the second number in his own table, the third number is sent by the user to the interlocutor together with the information to be transmitted, confirming that the user is the correct one, and the fourth number is provided by the interlocutor to the user confirming the reply; and so successively, exchanging as many numbers as required by the dialogue; and after the numbers in a row of the table have been used in a dialogue, this row is marked so that it is not used again.

2. Authentication procedure, according to claim 1, characterized in that the third and successive numbers can be used as keys for encrytion/unencrytion of the information transmitted, after the authentication process, throughout the dialogue.

3. Authentication procedure, according to claim 1, characterized in that the row used in the authentication process is chosen randomly.

4. Authentication procedure, according to claim 1, characterized in that in the case of two or more interlocutors, the keys stored in each row of the tables can be divided into two or more groups, with each group of keys available to a user being shared by said user and by another interlocutor participating in the dialogue, so that each row of its table of keys will have as many groups of keys as there are interlocutors participating with the user in the dialogue.
